(19) United States
(12) Patent Application Publication
(10) Pub. No.: US 2026/0275004 A1
(43) Pub. Date: Sep. 17, 2026

(54) SPHERICAL CATALYST FOR OLEFIN POLYMERIZATION

(71) Applicant: Zhejiang University, Zhejiang (CN)

(72) Inventors: Wei LI, Zhejiang (CN); Jingdai WANG, Zhejiang (CN); Yongrong YANG, Zhejiang (CN); Gan TAO, Zhejiang (CN); Tao GUO, Zhejiang (CN)

(73) Assignee: Zhejiang University, Zhejiang (CN)

(21) Appl. No.: 19/167,238

(22) PCT Filed: Mar. 26, 2024
(86) PCT No.: PCT/CN2024/083778

§ 371 Date: Sep. 19, 2025

(30) Foreign Application Priority Data
Mar. 27, 2023 (CN) 202310325605.7

(51) Int. Cl. C08F 4/02; C08F 10/00

(52) U.S. Cl. CPC C08F 4/022; C08F 10/00

(57) ABSTRACT

The present invention provides a spherical catalyst for olefin polymerization. In the present invention, first, a magnesium compound is reacted with an alcohol mixture in the presence of polyvinylpyrrolidone and a multi-polar functional group compound, to produce a complex solution; the complex solution reacts with an alkylene oxide compound to produce a solid adduct; the solid adduct is washed to obtain a spherical carrier; the spherical carrier reacts with a titanium compound to obtain an intermediate product; the intermediate product reacts with titanium tetrachloride to obtain the spherical catalyst. The preparation process for the catalyst provided by the present invention is simple and feasible, and produces a spherical catalyst having well-defined morphology and controllable size. When used for olefin polymerization, particularly ethylene polymerization, the catalyst exhibits high activity, good hydrogen regulation sensitivity, and a relatively high 1-hexene insertion rate. In addition, polymer particles obtained using the catalyst have low fine powder content.

### CROSS-REFERENCE TO RELATED APPLICATIONS

The application claims priority to the Chinese Application No. 202310325605.7, filed on Mar. 27, 2023, which is herein specifically and entirely incorporated by reference.

### FIELD

The present invention belongs to the field of olefin polymerization catalysts, in particular relates to a spherical catalyst for olefin polymerization.

### BACKGROUND

In order to prepare a spherical polyethylene having regular morphology, high bulk density, and low fine powder content, those skilled in the art generally prepare the spherical catalyst based on the “complexing effect” by initially producing a spherical carrier, and then loading titanium tetrachloride on the carrier. The mainstream spherical catalysts mainly use the magnesium chloride alcohol adduct or magnesium ethoxide as the carrier at present.

CN101544710A discloses a method for preparing an alcohol adduct containing ternary components of magnesium halide, alcohol and polyether. The preparation method comprises: reacting the ternary components at a high temperature to form a mixture in a molten state, and then quenching with a low temperature inert medium for molding. The obtained carrier exhibits desirable dispersibility, good particle morphology and small particle size, when the catalyst supported on the carrier is used for olefin polymerization, particularly ethylene polymerization, the catalyst exhibits high activity, the produced polymer has good morphology and low fine powder content. However, the preparation process is complicated and requires a high energy consumption; moreover, in order to avoid fracture of the catalyst prepared from the alcohol adduct during the polymerization process, a dealcoholization step shall be introduced, which further increases the energy consumption.

CN102040680A discloses a novel magnesium alkoxy spherical carrier and a preparation method thereof, and the magnesium alkoxy spherical carrier reacts with titanium tetrachloride in the presence of an internal electron donor to prepare a catalyst. The preparation method does not require quenching to precipitate the carrier, the operation is simple, the catalyst exhibits high activity when used for propylene polymerization, the catalyst shows desirable hydrogen regulation sensitivity while maintaining high polymerization activity and orientation ability, and the polymer has high stereoregularity at a high melt index. However, the carrier has a poor mechanical strength, is prone to fracture during the violently exothermic titanium loading process, when it is used for propylene polymerization, the bulk density of the finally produced polypropylene is low.

CN1563112A discloses a preparation method for an olefin polymerization catalyst loaded on spherical MgCl₂-alcohol-organic complexing agent carrier, the preparation method includes: introducing internal electron donor diisobutyl phthalate (DIBP) in situ into the carrier synthesis, the obtained carrier has a high mechanical strength, on this basis, titanium tetrachloride is added for preparing a spherical catalyst. However, the preparation method has the defects that the obtained catalyst has a large particle diameter, a wide distribution (D₅₀:70-200 μm) of particles, and a low propylene polymerization activity.

To sum up, the existing olefin polymerization catalyst carriers and the preparation methods have problems, such as the carrier is prone to fracture during the titanium loading process, the preparation process is complicated, and the catalyst has a poor polymerization performance.

### SUMMARY

For the sake of improving mechanical strength of the carriers, simplifying the preparation process of said carriers, saving energy, and fulfilling the purpose of increasing the commercial value of the olefin polymerization catalyst, the present invention provides a spherical catalyst for olefin polymerization, wherein the catalyst is prepared with the following steps:
(1) Reacting a magnesium compound with an organic compound containing active hydrogen in the presence of polyvinylpyrrolidone and a multi-polar functional group compound at a temperature of 30-160° C. to form a complex solution;
(2) Reacting the complex solution with an epoxy compound to precipitate a solid compound;

The epoxy compound is represented by formula (I):

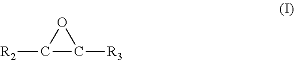

In formula (I), R₂ and R₃ are each independently selected from hydrogen, C₁-C₅ straight or branched chain alkyl, wherein the hydrogen on the alkyl may be unsubstituted, or may be optionally substituted by a halogen atom X;
(3) Washing the solid compound obtained in step (2) with an inert alkane solvent to obtain a magnesium compound spherical carrier;
(4) Dispersing the magnesium compound spherical carrier obtained in step (3) in a high-viscosity inert hydrocarbon solvent, and adding a titanium compound to carry out a reaction at a low temperature to obtain an intermediate product;

The titanium compound is represented by formula (II):

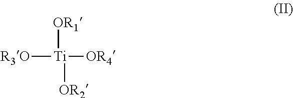

The groups R₁′, R₂′, R₃′, R₄′ in formula (II) are each independently selected from C₁-C₁₀ alkyl;
(5) Dispersing the intermediate product in a high-viscosity inert hydrocarbon solvent, adding titanium tetrachloride for performing a reaction at a low temperature, and washing the obtained solid product with an inert alkane solvent to prepare a spherical catalyst;

Wherein the multi-polar functional group compound in step (1) refers to a compound having a multi-polar functional group represented by the general formula CₙH₂ₙOₙ, n in the formula is 4 to 8;
The organic compound containing active hydrogen in step (1) refers to one or more compounds represented by formula R(OH)ₘ or a mixture thereof, wherein R is C₁-C₂₀ hydrocarbyl, and m≥1;
The inert alkane solvent in step (3) refers to a compound represented by formula CₙH₂ₙ₊₂ or a mixture thereof, wherein n≥5;
The high-viscosity inert hydrocarbon solvents of step (4) and step (5) each independently refer to alkyl substituted cycloalkanes and alkyl substituted aromatic hydrocarbons.

In the present invention, the polyvinylpyrrolidone may be conventional polyvinylpyrrolidone in the field, which can be prepared according to the methods in literatures or directly commercially available. The polyvinylpyrrolidone may have a weight average molecular weight within the range of 3,000-1,300,000 g/mol.

As a preferred scheme of the present invention, the polyvinylpyrrolidone is used in an amount of 0.001-0.1 mole, the multi-polar functional group compound is used in an amount of 0.002-0.2 mole, the organic compound containing active hydrogen is used in an amount of 2-20 mole, and the epoxy compound is used in an amount of 1-30 mole, the titanium compound is used in an amount of 0.05-1.5 mole, and the titanium tetrachloride is used in an amount of 0.5-15 mole, relative to per mole of magnesium.

In the present invention, the polyvinylpyrrolidone may be used in an amount of 0.001 mole, 0.003 mole, 0.005 mole, 0.007 mole, 0.008 mole, 0.01 mole, 0.02 mole, 0.04 mole, 0.06 mole, 0.08 mole, 0.1 mole, and a random value within the range consisting of two points thereof, relative to per mole of magnesium (magnesium compound). Preferably, the polyvinylpyrrolidone is used in an amount of 0.001-0.06 mole, relative to per mole of magnesium.

In the present invention, the multi-polar functional group compound may be used in an amount of 0.002 mole, 0.003 mole, 0.005 mole, 0.007 mole, 0.008 mole, 0.01 mole, 0.02 mole, 0.04 mole, 0.06 mole, 0.08 mole, 0.1 mole, 0.2 mole, and a random value within the range consisting of two points thereof, relative to per mole of magnesium (magnesium compound). Preferably, the multi-polar functional group compound is used in an amount of 0.002-0.08 mole, relative to per mole of magnesium.

In the present invention, the organic compound containing active hydrogen may be used in an amount of 2 mole, 4 mole, 6 mole, 8 mole, 10 mole, 12 mole, 14 mole, 16 mole, 18 mole, 20 mole, and a random value within the range consisting of two points thereof, relative to per mole of magnesium (magnesium compound). Preferably, the organic compound containing active hydrogen is used in an amount of 4-16 mole, relative to per mole of magnesium.

In the present invention, the epoxy compound may be used in an amount of 1 mole, 4 mole, 6 mole, 8 mole, 10 mole, 12 mole, 14 mole, 16 mole, 18 mole, 20 mole, 22 mole, 24 mole, 26 mole, 28 mole, 30 mole, and a random value within the range consisting of two points thereof, relative to per mole of magnesium (magnesium compound). Preferably, the epoxy compound is used in an amount of 1-18 mole, relative to per mole of magnesium.

In the present invention, the titanium compound may be used in an amount of 0.05 mole, 0.08 mole, 0.1 mole, 0.2 mole, 0.3 mole, 0.4 mole, 0.5 mole, 0.6 mole, 0.8 mole, 1 mole, 1.2 mole, 1.4 mole, 1.5 mole, and a random value within the range consisting of two points thereof, relative to per mole of magnesium (spherical carrier). Preferably, the titanium compound is used in an amount of 0.08-0.8 mole, relative to per mole of magnesium.

In the present invention, the titanium tetrachloride may be used in an amount of 0.5 mole, 1 mole, 4 mole, 6 mole, 8 mole, 10 mole, 12 mole, 14 mole, 15 mole, and a random value within the range consisting of two points thereof, relative to per mole of magnesium (intermediate product). The dosage of titanium tetrachloride may be a conventional dosage in the field, it may be conventionally selected by those skilled in the art as required, for example, the titanium tetrachloride may be used in an amount of 0.5-40 mole, relative to per mole of magnesium (intermediate product). Those skilled in the art may select a smaller dosage of titanium tetrachloride, or a larger dosage of titanium tetrachloride according to the conventional operations in the field.

As a preferred embodiment of the present invention, the high-viscosity inert hydrocarbon solvent in step (4) is used in an amount of 1,000-6,000 mL (it may be, for example, 1,000 mL, 2,000 mL, 3,000 mL, 4,000 mL, 5,000 mL, 6,000 mL, and a random value within the range consisting of two points thereof), relative to per mole of magnesium (spherical carrier).

As a preferred embodiment of the present invention, the high-viscosity inert hydrocarbon solvent in step (5) is used in an amount of 3,000-12,000 mL (it may be, for example, 3,000 mL, 4,000 mL, 5,000 mL, 6,000 mL, 7,000 mL, 8,000 mL, 9,000 mL, 10,000 mL, 11,000 mL, 12,000 mL, and ranges for any two points mentioned above), relative to per mole of magnesium (intermediate product).

As a preferred embodiment of the present invention, the multi-polar functional group compound in step (1) is one selected from the group consisting of glucose, fructose, sorbose, galactose, cyclohexanhexol and ribose, or a mixture thereof.

As a preferred embodiment of the present invention, the magnesium compound in step (1) is one selected from the group consisting of magnesium halide, magnesium phenoxide chloride, magnesium isopropoxide chloride and magnesium butoxide chloride, or a mixture thereof. The magnesium halide may be magnesium dichloride, magnesium dibromide and the like.

As a preferred version of the present invention, R(OH)ₘ in step (1) is a mixture of two or three selected from the group consisting of methanol, ethanol, propanol, n-butanol, isobutanol, pentanol, isopentanol, n-hexanol, 2-ethyl hexanol, isooctyl alcohol, ethylene glycol, propylene glycol and glycerol.

As a preferred embodiment of the present invention, the R(OH)ₘ in step (1) is selected from the group consisting of ethanol, n-butanol and isooctanol; more preferably, the molar ratio of ethanol, n-butanol and isooctanol is (0.1-0.8):(0.1-12):1.

As a preferred embodiment of the present invention, the epoxy compound in step (2) is ethylene oxide, propylene oxide, butylene oxide, epichlorohydrin, epoxy chlorobutane, epoxy bromopropane or epoxy bromobutane.

As a preferred embodiment of the present invention, the inert alkane solvent of step (3) is one selected from the group consisting of n-hexane, cyclohexane, n-heptane, n-octane and n-nonane, or a mixture thereof.

As a preferred embodiment of the present invention, the high-viscosity inert hydrocarbon solvent in step (4) and step (5) are each independently one selected from the group consisting of paraffin oil, white oil, methyl silicone oil and petrolatum, or a mixture thereof.

The methyl silicone oil may be a methyl silicone oil conventionally available in the field, for example, the methyl silicone oil available through purchase, for example, a commercially available methyl silicone oil (with a kinematic viscosity of 50±5 mm²/s at 25° C.). Likewise, the white oil is a white oil conventionally available in the field, such as No. 32 white oil (with a kinematic viscosity of 28.8-35.2 mm²/s at 40° C.), No. 68 white oil, No. 100 white oil.

As a preferred embodiment of the present invention, the low temperatures in step (4) and step (5) are each independently a temperature from −40° C. to 0° C., preferably a temperature from −20° C. to −10° C.

As a preferred embodiment of the present invention, the preparation process of said carrier and said catalyst are both carried out under a nitrogen atmosphere.

The present invention further provides an use of a polymerization catalytic system comprising the aforesaid spherical catalyst component in the α-olefin polymerization.

The α-olefin is represented by general formula CH₂═CHR₁, and preferably, R₁ is hydrogen or C₁-C₁₂ alkyl. The α-olefin polymerization may be an oligomerization reaction of α-olefin, or a copolymerization reaction of α-olefin as one of polymerized monomers. For example, the α-olefin may be at least one selected from the group consisting of ethylene, propylene, butene, pentene and hexene.

According to the present invention, the conditions of α-olefin polymerization may be the conventional polymerization conditions in the field, for example, the conditions of α-olefin polymerization may comprise: the polymerization temperature is within the range of 50-150° C., the polymerization time is within the range of 0.08-10 h, and the polymerization pressure is within the range of 0.3-50 bar.

In the present invention, 1 bar=0.1 MPa, and the pressure refers to a gauge pressure.

According to the present invention, the co-catalyst used in the α-olefin polymerization may be a conventional co-catalyst in the field, for example, the co-catalyst is AlR′ₚX₃₋ₚ, where p can be an integer of 1-3, R′ may be C₁-C₁₀ alkyl, and X may be a halogen atom; specifically, the co-catalyst may be at least one selected from the group consisting of trimethylaluminum, triethylaluminum, diethylaluminum chloride, triethylbutylaluminum, and trioctylaluminum.

According to the present invention, the dosage of said co-catalyst may be a conventional dosage in the field, for example, the molar ratio of the spherical catalyst calculated in terms of Ti to the co-catalyst calculated in terms of Al may be 0.0005-1, or 0.001-0.05.

According to the present invention, the solvent adopted in the polymerization process may be a conventional solvent in the art, the solvent may be alkane (e.g., n-heptane), aromatic hydrocarbon, etc.

The preparation process for the catalyst provided by the present invention is simple and feasible, and produces a spherical catalyst having well-defined morphology and controllable size. When used for olefin polymerization, particularly ethylene polymerization, the catalyst exhibits high activity, good hydrogen regulation sensitivity, and a relatively high 1-hexene insertion rate. In addition, polymer particles obtained by using the catalyst have low fine powder content.

### BRIEF DESCRIPTION OF THE DRAWINGS

FIG. 1 illustrates a topographical view of the spherical catalyst prepared in Example 1;

FIG. 2 shows a particle size distribution diagram of the catalyst prepared in Example 1;

FIG. 3 illustrates a topographical view of the spherical polymer particles prepared in Example 1;

FIG. 4 shows a particle size distribution diagram of the polymer particles prepared in Example 1;

FIG. 5 shows a sphericity degree distribution diagram of the polymer particles prepared in Example 1;

FIG. 6 illustrates a particle size distribution diagram of the catalyst prepared in Example 4.

### DETAILED DESCRIPTION

The present invention will be further described and explained with reference to specific embodiments. The embodiments merely demonstrate of the present invention, instead of imposing definitions and limitations to the protection scopes. The technical features of the various embodiments of the present invention may be combined accordingly in the absence of mutual conflict.

### Test Method:

1. The Ti content and Mg content of the catalyst or carrier was determined by an inductively coupled plasma emission spectrometer (ICP-AES). The specific test procedures included: approximately 10-20 mg of catalyst or carrier was weighed and poured into a clean glass vial equipped with small magnetons, 10 ml of dilute sulfuric acid solution (1.0 mol/L) was added, and then placed the mixed solution on a stirring device for stirring at least 8 h, the mixed solution was filtered into the glass vial by using a filter needle, an equivalent amount of catalyst or carrier solution was extracted and placed in the test instrument to measure the Ti content and Mg content of the catalyst or carrier.

2. The catalyst morphology was observed by the scanning electron microscopy (SU8010, USA), the particle size and particle size distribution of the catalyst were analyzed and measured through the combination of said scanning electron microscopy and the software Image J. The specific test steps included: the double-sided conductive adhesive was attached on the electron microscope stage, the electron microscope stage was transferred to a glove box, the carrier particles were sprinkled, the particles not being adhered on the surface were blown off by using an ear washing ball, and transferred into a scanning electron microscope sample chamber for photographing; the SEM images were opened by using the software Image J, the operations of Find edge-Threshold (8-bit)-Fill holes-Watershed were conducted in sequence, the sphericity degree was limited to the range of 0.5-1.0, and the statistical range of area was limited to 4-10,000 μm²; 10 SEM images were adopted for each sample, particle size data was summarized and fed into the software Origin, the values of D10, D50, D90 and Span were calculated.

3. The weight average molecular weight (Mw) and molecular weight distribution (MWD) of the polymer were measured by using the High Temperature Gel Permeation Chromatograph (HT-GPC, PL-GPC-220, UK). The specific test steps included: the mobile phase of testing was 1,2,4-trichlorobenzene (HPLC grade, Honeywell, USA), the flow rate was 1.0 mL/min, and the temperature was 150° C.; the molecular weight standard curve was calibrated with a very narrow distribution of Polystyrene (PS) as the standard sample.

4. The comonomer content of the polymer was determined using a nuclear magnetic resonance instrument (Bruker AC-80, 400 MHz). The specific test steps included: prior to the testing, the polymer was dissolved in deuterated ortho-dichlorobenzene, the test temperature was 120° C., and the comonomer content (i.e., insertion rate of comonomer) of the polymer was calculated based on the nuclear magnetic resonance C spectrum (¹³C NMR) of the polymer sample.

5. The microscopic morphology of the polymer particles was observed by using the scanning electron microscopy (SU3500/SU8010, USA). The specific test steps included: the double-sided conductive adhesive was attached on the electron microscope stage, the polymer particles were sprinkled, the particles not being adhered on the surface were blown off by using an ear washing ball, and transferred into a scanning electron microscope sample chamber for photographing; before the SEM test, the samples to be tested were subjected to surface spraying Pt treatment for 60 s, in order to improve conductivity of the samples.

6. The apparent density of the polymer particles was measured according to the American standard ASTM-D1895 compiled by the American Society for Testing Materials (ASTM).

7. The sphericity degree and particle size distribution of the polymer were determined by using the BT-2900LD dynamic image particle size and shape analysis system (dry method). The specific test steps included: about 20 g of the sample was placed in a hopper for material storage, the particles were dispersed through an electromagnetic vibration feeder and a material dispersion chute, and the sample fell free from a terminal of the material dispersion chute, the images of particles during the falling process were photographed by a high speed camera, and the images were analyzed by a computer to obtain the average particle size and particle shape data.

The magnesium halide MgX₂ was selected as an example of the magnesium compound, the preparation route of the spherical catalyst in the present invention was as follows:

### 1. The Preparation of a Spherical Carrier

(a) The magnesium halide MgX₂ was reacted with an alcohol mixture in the presence of polyvinylpyrrolidone and a multi-polar functional group compound CₙH₂ₙOₙ at a temperature condition of 30-160° C. under the protection of nitrogen gas to form a complex solution;
(b) The complex solution was subjected to the reaction with an alkylene oxide compound represented by formula (I) at a temperature of 30-160° C. to produce a solid adduct, and the solid adduct obtained in step (2) was washed with an inert alkane solvent to obtain a magnesium halide spherical carrier.

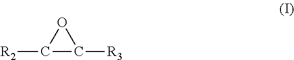

In formula (I), R₂ and R₃, which were the same or different, were hydrogen or C₁-C₅ straight or branched chain alkyl, wherein the hydrogen on the alkyl was optionally substituted by a halogen atom X;

The multi-polar functional group compound represented by formula CₙH₂ₙOₙ was one selected from the group consisting of glucose, fructose, sorbose, galactose, cyclohexanhexol and ribose, or a mixture thereof.

The epoxy compound represented by formula (I) was one selected from the group consisting of ethylene oxide, propylene oxide, butylene oxide, epichlorohydrin, epoxy chlorobutane, epoxy bromopropane and epoxy bromobutane, or a mixture thereof.

### Preparation of the Spherical Catalyst

The aforementioned spherical carrier was dispersed in a high-viscosity inert hydrocarbon solvent, a titanium compound was added to carry out a reaction at a low temperature to obtain an intermediate product, the intermediate product was dispersed in a high-viscosity inert hydrocarbon solvent, a titanium tetrachloride was added for performing a reaction at a low temperature, the obtained solid product was washed with an inert alkane solvent to prepare a spherical catalyst.

The titanium compound was represented by formula (II):

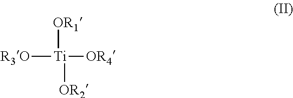

The groups R₁′, R₂′, R₃′, R₄′ in formula (II) were the same or different, such as C₁-C₁₀ alkyl.

The high-viscosity inert hydrocarbon solvent may be one selected from the group consisting of decane, paraffin oil, white oil, methyl silicone oil and petrolatum, or a mixture thereof.

The polyvinylpyrrolidone was used in an amount of 0.001-0.1 mole, the multi-polar functional group compound was used in an amount of 0.002-0.2 mole, the mixed alcohol was used in an amount of 2-20 mole, the epoxy compound was used in an amount of 1-30 mole, the titanium compound was used in an amount of 0.05-1.5 mole, and the titanium tetrachloride was used in an amount of 0.5-15 mole, relative to per mole of magnesium.

The present invention will be further described below with reference to examples.

Polyvinylpyrrolidone (PVP) had a weight average molecular weight within the range of 100,000-150,000 g/mol;

The methyl silicone oil had a kinematic viscosity of 50±5 mm²/s at 25° C.;

The white oil was No. 32 white oil with a kinematic viscosity of 28.8-35.2 mm²/s at 40° C.

### Example 1

### (1) Preparation of a Carrier

Under the protection condition of N₂, 10 g of MgCl₂, 160 mg of galactose, 1.6 g of PVP (0.0002 mol) and a certain amount of the mixed alcohol (a molar ratio of MgCl₂:ethanol:n-butanol:Isooctanol=1:3:7:2) were added into a three-port flask with a volume of 250 ml in sequence, the stirring rate was 600 rpm, the temperature was increased to the reaction temperature of 70° C., after the solid were completely dissolved, the reaction was continued for 1 h. 30 ml of epichlorohydrin (0.384 mol) was slowly and dropwise added by a micro-injection pump, a white to pale yellow solid was gradually precipitated during the dropwise adding process, which was accomplished in 1 h, the reaction was continued for 1 h, and then stopped. After the standing still treatment, the supernatant was removed, the solid was washed with n-hexane for three times, and subjected to the vacuum drying treatment in an ambient temperature for 4 h to obtain the carrier (white powder).

### (2) Preparation of a Catalyst

3 g of the obtained carrier (Mg content of the carrier was 0.0221 mol) was dispersed in a 100 ml three-port flask equipped with 50 ml methyl silicone oil; under the protection of nitrogen gas, the flask was placed in a constant temperature bath of −20° C., and a mechanical stirring (120 rpm) was performed to ensure homogeneous dispersion of the carrier in the system; after the system was stirred for 30 min and the temperature was reduced to a lower temperature, 0.75 ml tetrabutyl titanate (0.0022 mol) was dropwise added by using a micro-injection pump for 1 h; after the completion of the dropwise adding process, the three-port flask was heated to 60° C. at a temperature-rise rate of 0.5° C./min while stirring, the reaction was continued for 2 h. After the reaction was completed, the reaction solution was subjected to the standing still treatment, the supernatant was removed, the reaction product was washed with n-hexane for three times, and subjected to the vacuum drying treatment in an ambient temperature for 4 h to obtain to obtain the pretreated carrier (i.e., an intermediate product).

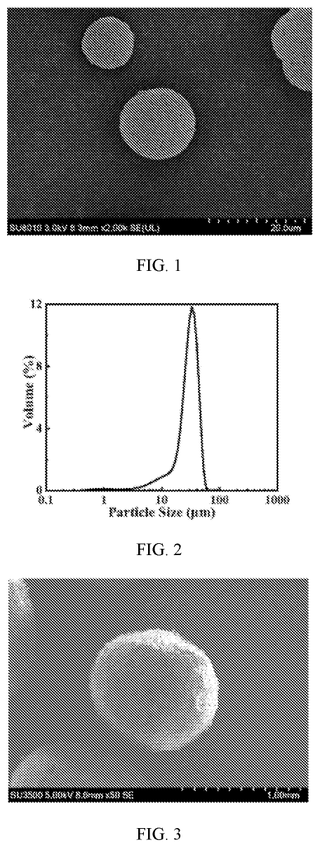

1 g of the pretreated carrier (Mg content of the pretreated carrier was 0.0089 mol) was dispersed in a 100 ml three-port flask charged with 50 ml of methyl silicone oil; under the protection of nitrogen gas, the flask was placed in a constant temperature bath of −15° C., and a mechanical stirring (60 rpm) was performed during the period; after the system was stirred for 30 min and the temperature was reduced to a lower temperature, 12.5 ml of TiCl₄ (0.1138 mol) was dropwise added for 3 h; after the completion of the dropwise adding process, the three-port flask was heated to 90° C. at a temperature-rise rate of 0.5° C./min while stirring, the reaction was continued for 2 h; the methyl silicone oil and the unreacted TiCl₄ were filtered out, the reaction product was washed with 300 ml of n-hexane in three batches; the flask was again placed in a constant temperature bath of −15° C., the steps of dropwise adding of TiCl₄, heating, reaction and washing were repeated; after the washing process was finished, the reaction product was subjected to the vacuum drying treatment in an ambient temperature for 4 h to obtain to obtain the spherical catalyst with a titanium content of 9.1 wt %, the catalyst exhibited a spherical morphology as shown in FIG. 1, the average particle diameter (D50) was 42.74 μm, and the particle diameter distribution was uniform, as shown in FIG. 2.

### (3) Ethylene Polymerization

The experiments of ethylene polymerization were carried out in a 1 L reactor using the prepared spherical catalyst; the solvent was n-heptane, the reaction temperature was 70° C., the spherical catalyst and the co-catalyst Triethylaluminum (TEA) were added according to an Al/Ti molar ratio of 100, the polymerization time was 1 h, the polymerization pressure was 4 bar.

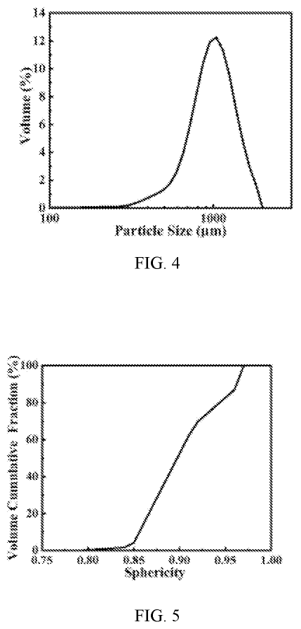

Polymerization activity was 10134gPE/gCat, the polymerization product had a weight average molecular weight (Mw) of 100×10⁴ g/mol, and a Molecular Weight Distribution (MWD) of 4.0, the apparent density of polymer particle was 0.31 g/cm³, the appearance of the polymer particle exhibited a well-defined and regular spherical morphology as shown in FIG. 3, the average particle diameter was 1,040 μm, and the particle diameter distribution was uniform, as shown in FIG. 4. The sphericity degree result was shown in FIG. 5, an average sphericity degree was 0.911.

### Example 2

The carrier and the catalyst were prepared according to the method in Example 1, and the ethylene polymerization was carried out according to the process in Example 1, except for that 10 mL of 1-hexene was further added. The polymerization activity was 16214gPE/gCat, which was 60% higher than that of Example 1, the 1-hexene insertion rate in the polymerization product was 11.4 mol %, the polymerization product had a Mw of 82.9×10⁴ g/mol and a MWD of 5.7, and the remaining polymerization product characterization results were close to those of Example 1. The polymer particles had an apparent density of 0.30 g/cm³, an average particle diameter of 996 μm, and an average sphericity degree of 0.909.

### Example 3

The carrier and the catalyst were prepared according to the method in Example 1. Hydrogen gas was also introduced during the ethylene polymerization process, the pressure of the hydrogen gas was 3 bar, the pressure of the ethylene gas was 4 bar, and the total polymerization pressure was 7 bar. The remaining ethylene polymerization conditions were the same as those in Example 1. The polymerization activity was reduced by 80% compared to Example 1, the weight average molecular weight of the polymer was reduced to 17% (16.76×10⁴ g/mol) of the polymer in Example 1, the hydrogen regulation effect was remarkable, and the remaining polymerization product characterization results were close to those of Example 1. The MWD of the polymer product was 4.6, the polymer particles had an apparent density of 0.38 g/cm³, an average particle diameter of 897 μm, and an average sphericity degree of 0.913.

### Comparative Example 1

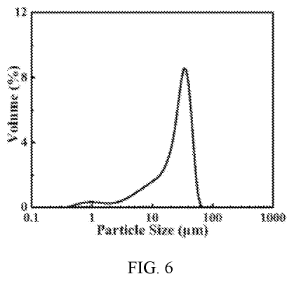

The carrier was prepared according to the method in Example 1, except that galactose was not added, the catalyst preparation and the ethylene polymerization were performed according to the same method as in Example 1. The particle size distribution of prepared catalyst was non-uniform, and tails (at about 1 μm) were present in the direction of the small particle size, and the results were shown in FIG. 6. The polymerization activity was 5,000gPE/gCat, the product had a high content of fine powder, and a low sphericity degree. The polymerization product had a Mw of 96×10⁴ g/mol and a MWD of 8.6; the polymer particles had an apparent density of 0.27 g/cm³, an average particle diameter of 765 μm, and an average sphericity degree of 0.798.

### Example 4

The carrier was prepared according to the method in Example 1, except the galactose was replaced with fructose. The preparation of a catalyst and the ethylene polymerization process were the same as those in Example 1. The characterization results of the catalyst and the polymerization product were close to those of Example 1. The polymerization activity was 13764gPE/gCat, the polymerization product had a Mw of 118×10⁴ g/mol and a MWD of 3.7; the polymer particles had an apparent density of 0.33 g/cm³, an average particle diameter of 1,124 μm, and an average sphericity degree of 0.912.

### Example 5

The catalyst was prepared according to the method in Example 1, except that the methyl silicone oil was replaced with white oil, the carrier preparation and the ethylene polymerization were performed according to the same method as in Example 1. The characterization results of the catalyst and the polymerization product were similar with those in Example 1. The polymerization activity was 12891gPE/gCat, the polymerization product had a Mw of 106×10⁴ g/mol and a MWD of 4.1; the polymer particles had an apparent density of 0.32 g/cm³, an average particle diameter of 1,071 μm, and an average sphericity degree of 0.908.

### Comparative Example 2

The catalyst was prepared according to the method in Example 1, except that the methyl silicone oil was replaced with n-heptane. The carrier preparation and the ethylene polymerization were the same as those in Example 1. It was unsuccessful in preparing a spherical catalyst, the polymer product had a high content of fine powder, and the apparent density of the polymer product was low. The polymerization activity was 11281gPE/gCat, the polymerization product had a Mw of 87×10⁴ g/mol and a MWD of 6.8; the polymer particles had an apparent density of 0.22 g/cm³, an average particle diameter of 689 μm, and an average sphericity degree of 0.29.

### Comparative Example 3

The catalyst preparation and the ethylene polymerization were implemented according to the method of Example 1, except that the catalyst preparation process did not include a step of preparing a pretreated carrier, that is, the carrier was directly reacted with TiCl₄ to prepare the catalyst. A portion of the catalyst exhibited fracture and collapse, a large amount of fine powder appeared in the polymerization product, and the apparent density of the polymerization product was low.

The polymerization activity was 12487gPE/gCat, the polymerization product had a Mw of 94×10⁴ g/mol and a MWD of 5.6; the polymer particles had an apparent density of 0.28 g/cm³, an average particle diameter of 788 μm, and an average sphericity degree of 0.764.

### Example 6

### (1) Preparation of a Carrier

Under the protection condition of N₂, 10 g of MgCl₂, 80 mg of galactose, 1.2 g of PVP (0.0001 mol) and a certain amount of the mixed alcohol (a molar ratio of MgCl₂:ethanol:n-butanol:Isooctanol=1:4:5:1) were added into a three-port flask with a volume of 250 ml in sequence, the stirring rate was 600 rpm, the temperature was increased to the reaction temperature of 80° C., after the solid were completely dissolved, the reaction was continued for 2 h. 20 ml of epichlorohydrin (0.2557 mol) was slowly and dropwise added by a micro-injection pump, a white to pale yellow solid was gradually precipitated during the dropwise adding process, which was accomplished in 1.5 h, the reaction was continued for 1.5 h, and then stopped. After the standing still treatment, the supernatant was removed, the solid was washed with n-hexane for three times, and subjected to the vacuum drying treatment in an ambient temperature for 4 h to obtain the carrier (white powder).

### (2) Preparation of a Catalyst

3 g of the obtained carrier (Mg content of the carrier was 0.0236 mol) was dispersed in a 100 ml three-port flask equipped with 60 ml methyl silicone oil; under the protection of nitrogen gas, the flask was placed in a constant temperature bath of −30° C., and a mechanical stirring (120 rpm) was performed to ensure homogeneous dispersion of the carrier in the system; after the system was stirred for 30 min and the temperature was reduced to a lower temperature, 0.9 ml tetrabutyl titanate (0.0026 mol) was dropwise added by using a micro-injection pump for 1.5 h; after the completion of the dropwise adding process, the three-port flask was heated to 50° C. at a temperature-rise rate of 0.5° C./min while stirring, the reaction was continued for 2 h. After the reaction was completed, the reaction solution was subjected to the standing still treatment, the supernatant was removed, the reaction product was washed with n-hexane for three times, and subjected to the vacuum drying treatment in an ambient temperature for 4 h to obtain to obtain the pretreated carrier.

1 g of the pretreated carrier (Mg content of the pretreated carrier was 0.0089 mol) was dispersed in a 100 ml three-port flask charged with 60 ml of methyl silicone oil; under the protection of nitrogen gas, the flask was placed in a constant temperature bath of −40° C., and a mechanical stirring (60 rpm) was performed during the period; after the system was stirred for 30 min and the temperature was reduced to a lower temperature, 10 ml of TiCl₄ (0.0911 mol) was dropwise added for 2.5 h; after the completion of the dropwise adding process, the three-port flask was heated to 80° C. at a temperature-rise rate of 0.5° C./min while stirring, the reaction was continued for 3 h; the methyl silicone oil and the unreacted TiCl₄ were filtered out, the reaction product was washed with 300 ml of n-hexane in three batches; the flask was again placed in a constant temperature bath of −40° C., the steps of dropwise adding of TiCl₄, heating, reaction and washing were repeated; after the washing process was finished, the reaction product was subjected to the vacuum drying treatment in an ambient temperature for 4 h to obtain the spherical catalyst with a titanium content of 8.7 wt %.

(3) the Conditions of Ethylene Polymerization were the Same as Those in Example 1.

The catalyst had a spherical morphology, an average particle diameter was 38.74 μm, and the particle size distribution was uniform. The polymerization activity was 14532gPE/gCat, the polymerization product had a Mw of 121×10⁴ g/mol and a MWD of 4.2; the polymer particles had an apparent density of 0.33 g/cm³, an average particle diameter of 896 μm, and an average sphericity degree of 0.912.

The aforesaid examples merely demonstrate several embodiments of the present invention, and the description is concrete and detailed, but the embodiments cannot be considered as imposing limitations to the protection scopes of the present invention. A number of variations and modifications may be implemented by the ordinary skilled person in the art without departing from the inventive concept, each of the variations and modifications falls into the protection scopes of the present invention.

1. A spherical carrier for olefin polymerization, wherein the carrier is prepared with the following steps:
(1) reacting a magnesium compound with an organic compound containing active hydrogen in the presence of polyvinylpyrrolidone and a multi-polar functional group compound at a temperature of 30-160° C. to form a complex solution;
(2) reacting the complex solution with an epoxy compound to precipitate a solid compound;
the epoxy compound is represented by formula (I): 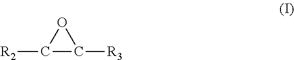
in formula (I), R₂ and R₃ are each independently selected from hydrogen, C₁-C₅ straight or branched chain alkyl, wherein the hydrogen on the alkyl is optionally substituted by a halogen atom X;
(3) washing the solid compound obtained in step (2) with an inert alkane solvent to obtain a magnesium compound spherical carrier;
wherein the multi-polar functional group compound in step (1) refers to a compound having a multi-polar functional group represented by the general formula CₙH₂ₙOₙ, where n is 4 to 8;
the organic compound containing active hydrogen in step (1) refers to one or more compound represented by formula R(OH)ₘ or a mixture thereof, wherein R is C₁-C₂₀ hydrocarbyl, and m≥1;
the inert alkane solvent in step (3) refers to a compound represented by formula CₙH₂ₙ₊₂ or a mixture thereof, wherein n≥5.

2. The spherical carrier of claim 1, wherein the polyvinylpyrrolidone is used in an amount of 0.001-0.1 mole, the multi-polar functional group compound is used in an amount of 0.002-0.2 mole, the organic compound containing active hydrogen is used in an amount of 2-20 mole, and the epoxy compound is used in an amount of 1-30 mole, relative to per mole of magnesium.

3. The spherical carrier of claim 1, wherein the multi-polar functional group compound in step (1) is one selected from the group consisting of glucose, fructose, sorbose, galactose and cyclohexanhexol, or a mixture thereof.

4. The spherical carrier of claim 1, wherein the magnesium compound in step (1) is one selected from the group consisting of magnesium halide, magnesium phenoxide chloride, magnesium isopropoxide chloride and magnesium butoxide chloride, or a mixture thereof.

5. The spherical carrier of claim 1, wherein R(OH)ₘ in step (1) is a mixture of two or three selected from the group consisting of methanol, ethanol, propanol, n-butanol, isobutanol, pentanol, isopentanol, n-hexanol, 2-ethyl hexanol, isooctyl alcohol, ethylene glycol, propylene glycol and glycerol.

6. The spherical carrier of claim 1, wherein the epoxy compound in step (2) is ethylene oxide, propylene oxide, butylene oxide, epichlorohydrin, epoxy chlorobutane, epoxy bromopropane or epoxy bromobutane.

7. The spherical carrier of claim 1, wherein the inert alkane solvent of step (3) is one selected from the group consisting of n-hexane, cyclohexane, n-heptane, n-octane and n-nonane, or a mixture thereof.

8. A spherical catalyst for olefin polymerization, wherein the catalyst is prepared with the following steps:
(A) dispersing the spherical carrier of claim 1 in a high-viscosity inert hydrocarbon solvent, and adding a titanium compound to carry out a reaction at a low temperature to obtain an intermediate product;
the titanium compound is represented by formula (II): 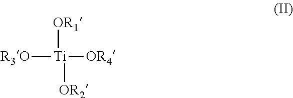
the groups R₁′, R₂′, R₃′, R₄′ in formula (II) are each independently selected from C₁-C₁₀ alkyl;
(B) dispersing the intermediate product in a high-viscosity inert hydrocarbon solvent, adding titanium tetrachloride for performing a reaction at a low temperature, and washing the obtained solid product with an inert alkane solvent to prepare a spherical catalyst;
wherein the high-viscosity inert hydrocarbon solvents of step (A) and step (B) each independently refer to alkyl substituted cycloalkanes and alkyl substituted aromatic hydrocarbons.

9. The spherical catalyst of claim 8, wherein the titanium compound is used in an amount of 0.05-1.5 mole and the titanium tetrachloride is used in an amount of 0.5-15 mole, relative to per mole of magnesium.

10. The spherical catalyst of claim 8, wherein the high-viscosity inert hydrocarbon solvent in step (A) and step (B) are each independently one selected from the group consisting of paraffin oil, white oil, methyl silicone oil and petrolatum, or a mixture thereof.

11. The spherical catalyst of claim 8, wherein the low temperatures in step (A) and step (B) are each independently a temperature from −40° C. to 0° C.

12. The spherical catalyst of claim 8, wherein the low temperatures in step (A) and step (B) are each independently a temperature from −20° C. to −10° C.

13. (canceled)

14. (canceled)

15. A-method for α-olefin polymerization, comprising the following steps: in the presence of a polymerization catalytic system comprising a spherical catalyst component according to claim 8, α-olefins are subjected to a polymerization reaction.
